(19) United States
(12) Patent Application Publication
(10) Pub. No.: US 2008/0201177 A1
(43) Pub. Date: Aug. 21, 2008

(54) FINANCIAL PRODUCT AND METHOD FOR COMPREHENSIVE ACCIDENTAL MEDICAL INSURANCE

(76) Inventors: Daniel Shawn Kennedy, McFarland, WI (US); Shannon Forest Kennedy, Janesville, WI (US)

Correspondence Address: Murphy Desmond S.C., P.O. Box 2038, Madison, WI, 53701-2038, US

(21) Appl. No.: 12/031,561

(22) Filed: Feb. 14, 2008

Related U.S. Application Data
(60) Provisional application No. 60/890,115, filed on Feb. 15, 2007.

(51) Int. Cl. G06Q 40/00

(52) U.S. Cl. 705/4

(57) ABSTRACT

The present invention is directed to a system, method, and product for providing comprehensive accident medical insurance. The invention manages the administration of medical insurance policy in which medical providers are paid on behalf of an Insured Person for all or part of medical expenses incurred by the Insured Person solely as a result of an accident.

### RELATED APPLICATION

The present application claims priority from and is a continuation-in-part of U.S. Provisional Patent Application 60/890,115 filed Feb. 15, 2007.

### BACKGROUND OF THE INVENTION

The present invention relates generally to the field of medical insurance, and more specifically to systems and methods for determining and providing comprehensively insuring against medical expenses incurred in an accident.

Health insurance, in general, is available in very limited forms. The definition of health insurance is insurance that pays for all or part of a person's sickness and accident medical care bills. The types of health insurance include group health plans, individual plans, workers' compensation, and government health plans such as Medicare and Medicaid. Health insurance can be further classified into fee-for-service (traditional insurance) and managed care. Both group and individual insurance plans can be either fee-for-service or managed care plans.

The following are types of Health care plans as included under the definition of Health Insurance:

Major Medical Insurance

Health Savings Account (HSA)

Health Maintenance Organization (HMO)

Referred Provider Organization (PPO)

Point of Service (POS)

Medicare

Hospital Indemnity

The above plans are broad and very expensive each with strict limitations as to who the Insured Persons may be and what the coverage is. Due to the expense, people do not purchase these plans individually. In addition, many companies are finding it extremely difficult to provide insurance to their employees.

Accident Medical Insurance is limited to paying for all or part of a person's medical expenses resulting from an accident. An accident means a sudden, unexpected and unintended event, which is identifiable and caused solely by an external physical force resulting in injury to an Insured Person. An accident does not include a loss due to disease or sickness. The only currently available form of Accident Medical Insurance is indemnity policies in which Insured Persons first pay the expense and then are reimbursed by the insurance company. Previous versions have been limited to fairly small amounts (equal or less than $25,000) when applied to adults or limited to healthy children, usually involved in athletics.

Currently, approximately 46.6 million Americans are uninsured. Often the cost of insurance is cited as the reason for not obtaining insurance. Many people are not supplied insurance through their workplace or the supplied insurance does not provide adequate coverage. This requires other forms of health insurance to be purchased either as primary or supplemental insurance.

As such, there is a long-felt and as yet unfulfilled need for people with no or too little insurance to have available a policy that is both broad and affordable for accidents. Insurance against higher expenses resulting from accidents is currently unavailable for most people. In addition, those who have some form of accident insurance must deal with low maximum claims and struggle with indemnity relationships with the insurance companies.

### BRIEF SUMMARY OF THE INVENTION

Comprehensive Accident Medical Insurance is high dollar limit insurance that pays medical providers of an Insured Person's medical care, on behalf of the Insured Person (i.e. an assignable benefit), for all or part of an Insured Person's accident medical care bills. Insurance benefits are paid similar to a Major Medical, HSA, HMO, POS, PPO, Hospital Indemnity, or Medicare plan, (hereafter collectively referred to as “Major Medical”) but limited to medical expenses incurred solely as the result of an accident.

Comprehensive accidental insurance may be used either as an alternative or substitute to Major Medical or as a supplement to concurrently held insurance. It can be either purchased by the Insured Person or given as part of an insurance package. It is compatible to supplement all Major Medical plans discussed above or purchased separately from a company separate from that providing the Insured Person with other insurance policies. It may also be offered by Major Medical as an alternative, substitute, or supplement to the current policies currently offered. It may be offered any of the following plan categories: Individual, Association Group, True Group, Voluntary Group, List Bill Group, Employer Sponsored, Employer Paid, Employee Paid, Partial Employer contribution. Regardless of the plan category, the plan may allow an employee to can take the invention policy with them if they leave the employer.

Unlike Major Medical, which often limits the insured population by the status of the Insured Persons, the invention methods do not necessarily limit population by status of the Insured Person. For example, the policy may be sold to a United States Citizens or Foreign Citizens living in the United States, Seasonal Employees, Full Time Employees, or even the unemployed.

### DETAILED DESCRIPTION OF THE INVENTION

The present invention is a method for providing comprehensive accidental medical insurance coverage to persons seeking high dollar limit insurance coverage for medical costs due to an accident. The Insurer will select a population of potential Insured Person wherein the medical costs incurred by that population due to accident has, over a set period of time, has been determined. That population may be broadly or narrowly defined. For example, the population may be current members of a given HMO, employees of a given company or residents of a given locale. The population need not currently carry other medical insurance. The focus of providing comprehensive medical insurance to expenses incurred solely due to accidents allows the policy to be available to a much broader audience for less expense than traditional Major Medical insurance. The present invention may be used as the sole source or as companion insurance by the Insured Person.

Next, the Insurer determines the number of accidents over the same period of time that gave rise to the medical costs. This number may be derived from a number of sources known by the average Insurer. The Insurer will then determine the mean medical cost per accident. By doing so, the insurer determines its expense for providing the insurance coverage for an accident for a person in the given population. By entering this figure into a software calculation program, the premium rate and deductible for an insured member of the population is calculated based on the net present value of the mean medical cost for each accident, the net present value of the insurer expense, a risk factor that an accident will exceed the calculated deductible, a probability percentage of the population that will become insured and the net present value of a return on investment of the premiums that are collected from the insured. This final calculation may have a profit margin entered into the formula in order to determine the premium rate and deductible. This profit margin may be zero and is best determined by the current state of the insurance market and medical expenses.

In an embodiment, the net present value of the premiums collected and the net present value of the return on investment exceeds the mean medical cost for each accident multiplied by the number of accidents that exceed the calculated deductible.

Many people are not able to obtain insurance due to prior or current health conditions. Either the insurance is too expensive or is declined to those with certain medical histories or current diseases or conditions. Populations found to be too high of risk for insuring are left without any health insurance whatsoever including accident insurance even though the condition that caused health insurance ineligibility has no impact on the likelihood of an accident or the type of injury sustained. The ineligible person is now left without any ability to insure the identical expenses that someone who is eligible for insurance would incur. It is a long felt yet unfulfilled need for those people who are not eligible for comprehensive Major Medical to be able to have comprehensive accident insurance.

By using those denied Major Medical Insurance as a defined population in this method, everyone is eligible for the plan regardless of their age, medical history, or current medical condition. This embodiment allows those previously unable to obtain comprehensive Major Medical insurance to now obtain comprehensive accident insurance.

In another population, medical history may be taken into account when determining the premiums. This embodiment takes into account that some medical conditions cause injuries due to accidents to be more severe or accidents more likely to occur. The Medical history may then be used to determine to which population the insured belongs. In the alternative, no medical history is taken and the population to which the insured belongs is defined in another way.

By using the claimed methods, the insurer is able to provide insurance to more populations then it could previously provide major medical insurance. The population may have either medical insurance or low dollar amount accident insurance. The method may be used to determine the premium rate and deductible for companion insurance in these cases. On the other hand, the population may not have other insurance or ways of covering such medical costs. The method is then used to determine the premium rate and deductible as the sole source of insurance for medical costs due to an accident.

When determining the deductibles and premium rates, a single flat premium may be given. This premium structure spreads the costs of severe injuries throughout the insured pool in order to have as low of costs possible for everyone. Alternatively, a population may have varied premiums depending on the amount of insurance coverage desired.

In another embodiment, everyone purchasing the policy is charged a different premium, based on age, sex or medical underwriting.

In another embodiment, the policy is offered to people who have been Declined, Rated, Ridered, and or Excluded a health insurance policy as those terms are currently understood in the health insurance industry.

In one embodiment, the benefits may be assignable rather than indemnity based. Therefore, the Insured Person does not need to pay for services and then be reimbursed by the insurance. Instead, the Insured Person's claim will be treated similar to most major medical insurance claims by presenting an Insured Person's card at the point of service, and the insurance company will pay the service provider directly. This allows the Insured Person to easily obtain his benefits without needing the cash on hand at the time the service is required.

Under indemnity plans, the Insured Person must have the cash on hand to pay the bills of service and then be reimbursed. This is a process involving a multitude of steps with money exchanging hands at least twice through the Insured Person as the Insured receives and pays the medical service provider and then submits it for reimbursement to the insurer. Whereas with assignable benefits, the Insured Person is no longer responsible for the bill at the time of service or soon thereafter. Nor must the money and bills pass through the Insured. Instead for the Insured Person, it is a one step process as the medical service provider bills and is paid by the insurer without any billing routed through the Insured.

Finally, all references, including the priority document, cited herein are hereby incorporated by reference. While the present invention has been described in considerable detail, it will be obvious to those skilled in the art that alterations may be made without departing from the concept and scope of the present invention as described in the following claims.

I/we claim:

1. A method for an insurer to provide insurance coverage for medical expenses arising from accidents comprising:
a) selecting a population of potential insured, wherein a medical cost sum incurred by the population due to accidents over a period of time has been determined;
b) determining a number of accidents over the period of time which gave rise to the medical cost sum;
c) determining a mean medical cost for each accident;
d) determining a insurer expense for providing the insurance coverage; and
e) entering the figures determined in steps a) through d) into a computer to determine a premium rate and a deductible for an insured in the population based upon the net present value of the mean medical cost for each accident, the net present value of the insurer expense, a risk factor that an accident will exceed the calculated deductible, a probability percentage of the population that will become insured and the net present value of a return on investment of the premiums that are collected from the insured.

2. The method of claim 1, further comprising entering a profit margin into the computer to determine the premium rate and the deductible.

3. The method of claim 1, wherein the net present value of the premiums collected and the net present value of the return on investment exceeds the mean medical cost for each accident multiplied by number of accidents that exceed the calculated deductible.

4. A system to provide insurance benefits for medical expenses arising from accidents comprising:
a) a computer to determine a premium rate and a deductible for an insured in a population based on a medical cost sum incurred by the population of potential insured due to accidents over a period of time, a number of accidents over the period of time which gave rise to the medical cost sum, a mean medical cost for each accident, and a insurer expense for providing the insurance coverage into a computer, wherein the computer accounts for the net present value of the mean medical cost for each accident, the net present value of the insurer expense, a risk factor that an accident will exceed the calculated deductible, a probability percentage of the population that will become insured and the net present value of a return on investment of the premiums that are collected from the insured; and
b) an insurance policy providing for the premium rate and the deductible calculated by the computer.

5. The system of claim 4, further comprising adjusting the premium rate based upon a medical condition of the insured.

6. The system of claim 4, wherein the policy provides for an assignment of the insurance benefits to a healthcare provider the insured.
